(19) United States
(12) Patent Application Publication
(10) Pub. No.: US 2026/0103426 A1
(43) Pub. Date: Apr. 16, 2026

(54) PROCESS FOR PRODUCING A HOT BLENDED MATERIAL OF AMORPHOUS SILICON DIOXIDE – CRYSTALLINE SILICON DIOXIDE, PROCESS FOR PRODUCING ARTIFICIAL STONE FROM THE MATERIAL BY PRESS-VIBRATION METHOD IN VACUUM ENVIRONMENT AND THE ARTIFICIAL STONE PRODUCT OBTAINED FROM THIS PROCESS

(71) Applicant: A&A GREEN PHOENIX GROUP JOINT STOCK COMPANY, Hanoi City (VN)

(72) Inventors: Nang Xuan Ho, Hanoi City (VN); Dung Tri Pham, Hanoi City (VN); Thuc Quang Dong, Hanoi City (VN); Oanh Thi Bui, Hanoi City (VN); Son Anh Trung Hoang, Hanoi City (VN); Cuong Manh Tran, Hanoi City (VN)

(21) Appl. No.: 19/117,194

(22) PCT Filed: Apr. 24, 2024
(86) PCT No.: PCT/IB2024/054009

§ 371 Date: Mar. 31, 2025

(30) Foreign Application Priority Data
Jul. 11, 2023 (VN) 1-2023-04552
Jan. 8, 2024 (VN) 1-2024-00127

(51) Int. Cl. C04B 26/18; C04B 14/06; C04B 14/22; C04B 40/00

(52) U.S. Cl. CPC C04B 26/18; C04B 14/06; C04B 14/22; C04B 40/0067; C04B 40/0085

(57) ABSTRACT

The present invention relates to process for producing a hot blended material of amorphous silicon dioxide-crystalline silicon dioxide (Hot Blending silica-PheniGlass™) with hardness greater than 5 Mohs, with silicon dioxide content is greater than 80% by weight wherein the crystalline silicon dioxide content is in range from 2 to 40% by weight, from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar. The present invention also relates to artificial stone product produced by using base resins such as unsaturated polyester, epoxy, acrylic or combination thereof and hot blended material of amorphous silicon dioxide-crystalline silicon dioxide wherein the artificial stone has a flexural strength ≥40 N/mm², a water absorption ≤0.025%, an impact resistance ≥3 J, as well as process for producing this artificial stone.

### FIELD OF THE INVENTION

The present invention relates to process for producing a hot blended material of amorphous silicon dioxide-crystalline silicon dioxide (Hot Blending silica-PheniGlass™) with hardness greater than 5 Mohs, with silicon dioxide content in range from 80% to 95% by weight wherein the crystalline silicon dioxide content is in range from 2 to 40% by weight, from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar. The present invention also relates to artificial stone product produced by using base resins such as unsaturated polyester, epoxy, acrylic or combination thereof and hot blended material of amorphous silicon dioxide-crystalline silicon dioxide wherein the artificial stone has a flexural strength ≥40 N/mm², a water absorption ≤0.025%, an impact resistance ≥3 J as well as process for producing this artificial stone.

### BACKGROUND OF THE INVENTION

In some recent studies, the use of materials such as quartz/silica sand, in general, during industrial production, generates silicon dioxide dust in crystalline form. This dust, when released into the air, can have a harmful effect on human health through the respiratory tract, causing a lung disease called silicosis. Therefore, there is a need for a material that has properties equivalent to quartz/silica sand but does not generate silica dust in in crystalline form or has limited controlled emission levels during industrial production.

Amorphous silica is a form of silica material with an amorphous structure, unlike quartz/silica sand in crystalline form. Therefore, during industrial production, no crystalline silica dust is emitted. However, in the production of artificial stone, amorphous silicon material is used only as a secondary type due to it has the SiO₂ ratio in range of 40 to 70% by weight (regular glass), which does not ensure the properties of artificial stone products, they are not commonly and widely used.

### SUMMARY OF THE INVENTION

The object of the present invention is to provide a process for producing a hot blended material of amorphous silicon dioxide-crystalline silicon dioxide (Hot Blending silica-PheniGlass™) from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar, after that the material is used as reinforcement for producing artificial stone product by press-vibration method in a vacuum environment.

To obtain the above-mentioned object, according to one aspect, the present invention provides a process for producing a hot blended material of amorphous silicon dioxide-crystalline silicon dioxide (Hot Blending silica-PheniGlass™) from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar, the process includes the following steps:
i) heating a mixture of sand, crushed glass and solid waste from quartz stone production in amount of from 60 to 90% by weight together with additional materials which are soda/feldspar (Na₂CO₃) in amount of from 1 to 13% by weight, aluminum oxide/feldspar powder (Al₂O₃) in amount of from 1 to 13% by weight; limestone/dolomite (CaCO₃/MgCO₃) in amount of from 5 to 13% by weight and processing aid at a temperature between 1000° C. and 1600° C. to obtain common molten frit (component A) with amorphous silicon dioxide content in range of from 40 to 80% by weight;
ii) preparing crystalline silicon dioxide (component B) from sand, quartz, cristobalite with a size ≤500 μm, with or without heating process from ambient temperature (25° C.) to 1600° C. before mixing with the component A, the heating depends on the viscosity of the component A and the mixing ratio of the materials comprising the component A and B;
iii) injecting, mixing and hot press-rolling the crystalline silicon dioxide (component B) into the molten amorphous silicon dioxide (component A), together with adjusting the injection pressure of the component B and the flow rate of the component A so that the proportion of the component A is in range from 60 to 95% by weight and the proportion of component B is in range of 2 to 40% by weight, wherein the total silicon dioxide content of the obtaining product ranges from about 80% to 95% by weight; wherein the mixture of A and B is mixed and homogenized through stages:
stage 1: injecting component B directly into the molten frit stream of component A, through the hot press-rolling mixing roller system which can adjust the rotating speed, moving speed in and out of the roller and distance between the two rollers to perform a hot rolling-mix for the first time, at this stage the mixture temperature ranges from 1000 to 1600° C.,
stage 2: passing the molten mixture through a cool rolling and mixing roller system which is primarily cooled by water or air and which can adjust the rotating speed, moving speed in and out of the roller and distance between the two rollers to perform a rolling mixing for the second time, at this stage the mixture temperature ranges from 500 to 1000° C.;
iv) passing the molten mixture through a mold or flat heat-resistant conveyor system that has vertical movement perpendicular to roller and mixing and rolling rollers in which the speed and distance between the roller and the conveyor belt can be adjusted in order to adjust the particle size as desired, wherein the roller is secondarily cooled by water or air, at this stage the mixture temperature ranges from 100 to 500° C.;
v) grinding the particles from step (iv) by a mill system to obtain the hot blended material of amorphous silicon dioxide-crystalline silicon dioxide (Hot Blending silica-PheniGlass™) with the desired sizes.

The advantage of this process is that the blended material (A and B) is cooled slowly to increase the hardness of the material, reduces surface cracking and does not require a drying step like the direct water-cooling system.

In one embodiment of the invention, the blended material has a hardness >5 Mohs, the surface is smooth and does not crack like regular frits and glass. Amorphous silicon dioxide is observed as transparent areas, while crystalline silicon dioxide is observed as opaque white areas. The structure and component ratios can be analyzed by X-ray diffraction (XRD) and infrared spectroscopy (FTIR).

The material particles obtained from grinding step are composed of amorphous silicon dioxide and crystalline silicon dioxide that is completely or partially enveloped by amorphous silicon dioxide in which the proportion of the component A is in range from 60 to 95% by weight and the proportion of component B is in range of 2 to 40% by weight according to the initially mixed ratio.

The blended material of amorphous silicon dioxide-crystalline silicon dioxide of the invention (Hot blending Silica-PheniGlass™) has a hardness >5 Mohs, smooth surface, reduced surface cracks compared to conventional frit products and especially with the advantage of not generating silica dust in the shaped form or controlled emission during the production and processing of a artificial stone products, thereby reducing harmful effects on human health through the respiratory tract due to the use of materials such as quartz/silica sand.

In one aspect, the present invention relates to blended material of amorphous silicon dioxide-crystalline silicon dioxide obtained from the process of the invention, wherein the material is consisting of chemical compositions as following:
80%<SiO₂<95% by weight, wherein the amorphous SiO₂ is in range from 60 to 95% by weight; crystalline SiO₂ is in range from 2 to 40% by weight;
1.0%<Na₂O<12% by weight;
1.5%<CaO/MgO<9% by weight;
1.0%<Al₂O₃<10% by weight;
wherein the other additives such as Fe₂O₃<0.1% by weight, TiO₂<0.1% by weight.

In one aspect, the present invention provides a process for producing artificial stone, wherein the process includes the following steps:
i) heating a mixture of sand, crushed glass and solid waste from quartz stone production in amount of from 60 to 90% by weight together with additional materials which are soda/feldspar (Na₂CO₃) in amount of from 1 to 13% by weight, aluminum oxide/feldspar powder (Al₂O₃) in amount of from 1 to 13% by weight; limestone/dolomite (CaCO₃/MgCO₃) in amount of from 5 to 13% by weight and processing aid at a temperature between 1000° C. and 1600° C. to obtain common molten frit (component A) with amorphous silicon dioxide content in range of from 40 to 80% by weight;
ii) preparing crystalline silicon dioxide (component B) from sand, quartz, cristobalite with a size ≤500 μm, with or without heating process from ambient temperature (25° C.) to 1600° C. before mixing with the component A, the heating depends on the viscosity of the component A and the mixing ratio of the materials comprising the component A and B;
iii) injecting, mixing and hot press-rolling the crystalline silicon dioxide (component B) into the molten amorphous silicon dioxide (component A), together with adjusting the injection pressure of the component B and the flow rate of the component A so that the proportion of the component A is in range from 60 to 95% by weight and the proportion of component B is in range of 2 to 40% by weight, wherein the total silicon dioxide content of the obtaining product ranges from about 80% to 95% by weight; wherein the mixture of A and B is mixed and homogenized through stages:
stage 1: injecting component B directly into the molten frit stream of component A, through the hot press-rolling mixing roller system which can adjust the rotating speed, moving speed in and out of the roller and distance between the two rollers to perform a hot rolling-mix for the first time, at this stage the mixture temperature ranges from 1000 to 1600° C.,
stage 2: passing the molten mixture through a cool rolling and mixing roller system which is primarily cooled by water or air and which can adjust the rotating speed, moving speed in and out of the roller and distance between the two rollers to perform a rolling mixing for the second time, at this stage the mixture temperature ranges from 500 to 1000° C.;
iv) passing the molten mixture through a mold or flat heat-resistant conveyor system that has vertical movement perpendicular to roller and mixing and rolling rollers in which the speed and distance between the roller and the conveyor belt can be adjusted in order to adjust the particle size as desired, wherein the roller is secondarily cooled by water or air, at this stage the mixture temperature ranges from 100 to 500° C.;
v) grinding the particles from step (iv) by a mill system to obtain the hot blended material of amorphous silicon dioxide-crystalline silicon dioxide (Hot Blending silica-PheniGlass™) with the desired sizes;
(vi) producing artificial stone products by using blended material of amorphous silicon dioxide-crystalline silicon dioxide obtained in the step (v) and base resins such as unsaturated polyester, epoxy, acrylic or combination thereof by press-vibration method in a vacuum environment, in which the ratio of base resin used is in range from 6 to 20% by weight and the ratio of blended material of amorphous silicon dioxide-crystalline silicon dioxide obtained in the step (v) is in range from 80 to 94% by weight.

The advantage of this process is that the blended material (A and B) is cooled slowly to increase the hardness of the material, reduces surface cracking and does not require a drying step like the water-cooling system.

In one embodiment of the invention, the blended material has a hardness >5 Mohs, smooth surface, and no crackings on surface compared to conventional frit and glass.

The mixture obtained after cooling will be sieved to remove the crystalline silicon dioxide (component B) that was not blended during the hot blending process between components A and B. This part is sieved and then go back to the hot blending stage to ensure that the resulting mixture is free of unblended crystalline silicon dioxide, mechanically bonded to amorphous silicon dioxide.

In one aspect, the present invention provides a artificial stone product obtained from the process of the invention, wherein the artificial stone product comprises base resins such as unsaturated polyester, epoxy, acrylic with the ratio in range from 6 to 20% by weight and reinforcement is the hot blended material of amorphous silicon dioxide-crystalline silicon dioxide (Hot blending Silica-PheniGlass™) with the ratio in range from 80 to 94% by weight, wherein the total ratio of silicon dioxide is range from 80% to 95% by weight and the artificial stone product has a flexural strength ≥40 N/mm², a water absorption ≤0.025%, an impact resistance ≥3 J.

### BRIEF DESCRIPTION OF DRAWINGS

FIG. 1 is a diagram of the equipment for the heating process and the mixing and press-rolling process to create a hot blended material of amorphous silicon dioxide-crystalline silicon dioxide (Hot blending Silica-PheniGlass™) according to an embodiment of the invention.

FIG. 2 depicts the mixing of a mixture of molten amorphous silicon dioxide (component A) and crystalline silicon dioxide (component B).

FIG. 3 shows the movement of the flow of crystalline silicon dioxide (component B) into the molten frit flow of amorphous silicon dioxide (component A) when blended.

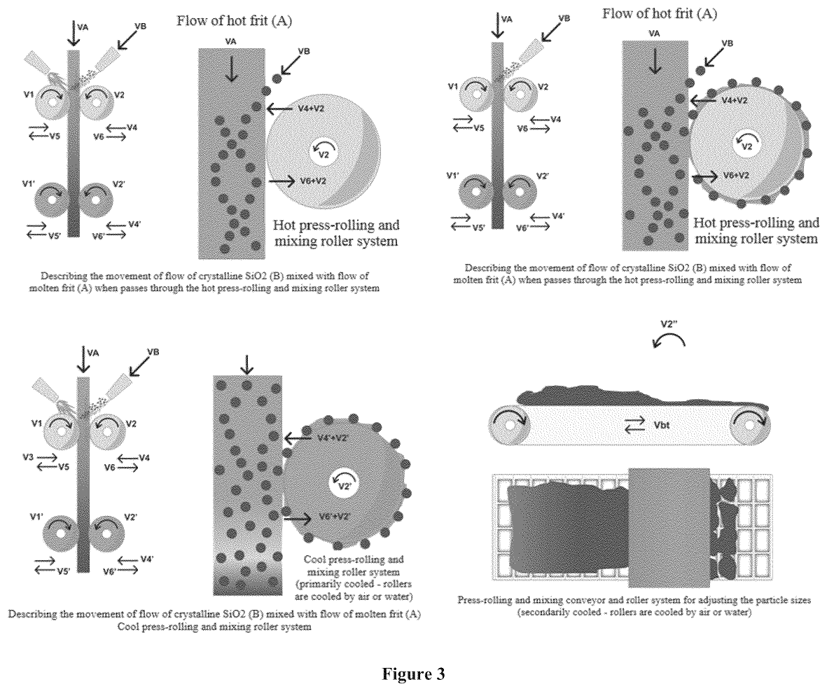

FIG. 4 is the morphology of the resulting hot blended material of amorphous silicon dioxide-crystalline silicon dioxide (Hot blending Silica-PheniGlass™) FIG. 5 is an artificial stone product using the material of Hot blending Silica-PheniGlass™ or mixture of materials of Hot blending Silica-PheniGlass™ and quartz, sand, cristobalite, glass, frit . . . .

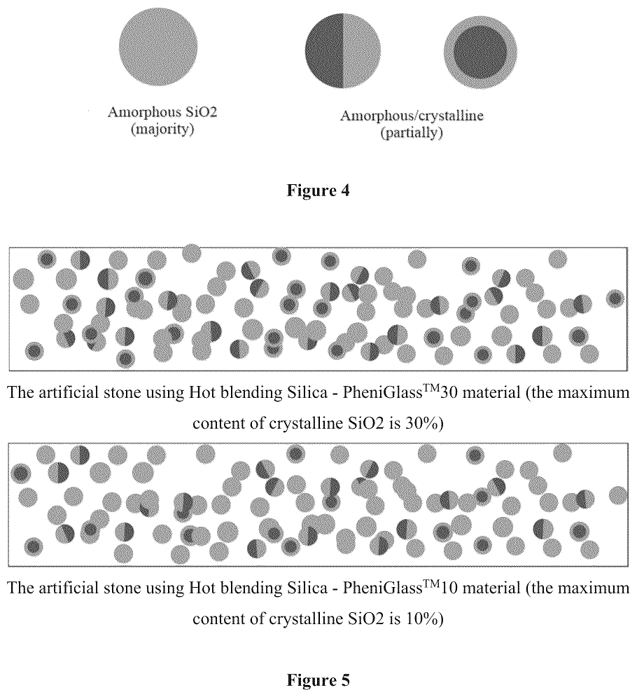

FIG. 6 is an image of the sample of the hot blended material of amorphous silicon dioxide-crystalline silicon dioxide (Hot Blending silica-PheniGlass™ M) before and after grinding grinding into granular strips under a microscope.

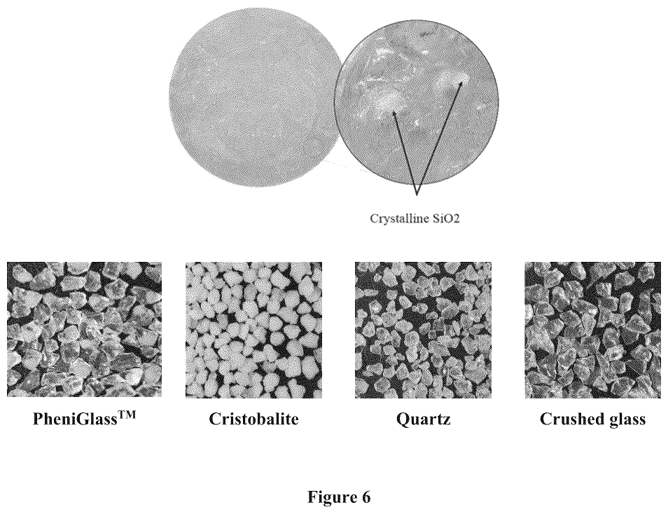

FIG. 7 shows the X-ray diffraction (XRD) and infrared spectroscopy (FTIR) of the sample of the hot blended material of amorphous silicon dioxide-crystalline silicon dioxide (Hot Blending silica-PheniGlass™)

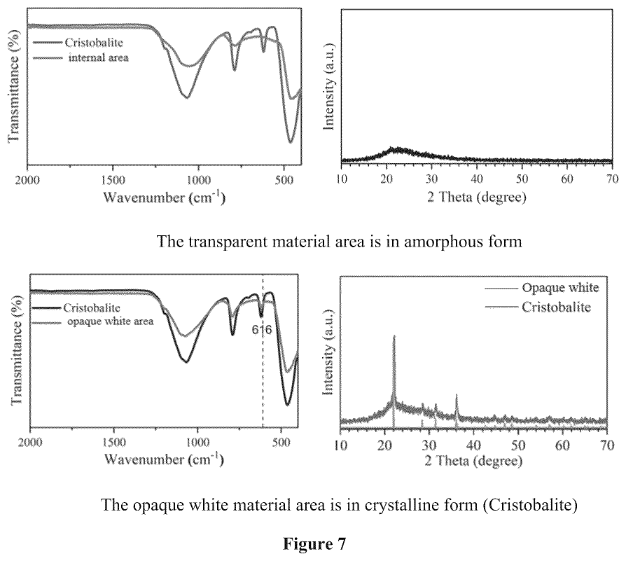

### DETAILED DESCRIPTION

Hereinafter, the preferred embodiments of the process according to the invention shall be described in more detail. However, note that the scope of the invention is not limited to the preferred embodiments described below as illustrative examples of the invention, and it should be understood that the scope of the invention includes all their modifications and other equivalent changes.

### Blending Components

### Sand

The sand used according to the invention is white sand that has an iron oxide content below the allowable level for the sand for use in glass production and does not require enrichment, has moisture content below 4.5%, and no clotted phenomenon.

### Crushed Glass

The crushed glass used according to the present invention is glass beads of various sizes such as 0.3÷0.6 mm, 1.2÷2.5 mm, 3.0÷5.0 mm, etc., purchased from suppliers of glass beads from recycled sources.

Solid Waste from Quartz Stone Production

Waste rock powder/burrs from production of artificial stone have particle size in range of 0.1 to 10 nm, waste products and by-products from the exploitation and processing of natural quartz stone.

Common materials for producing regular frit such as kaolin, schist, feldspar . . . .

Additives in the production process, metal oxides, color adjustment compounds . . . .

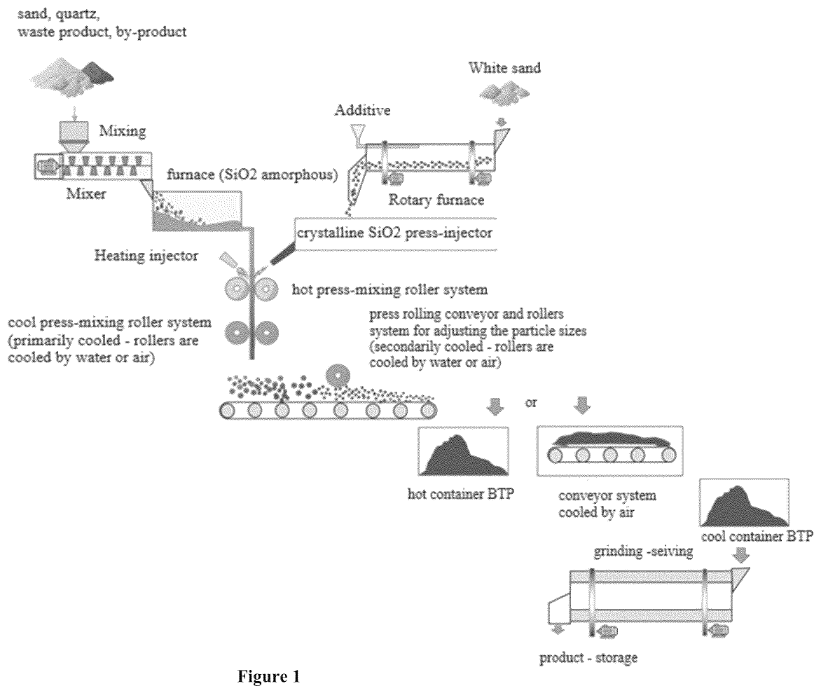

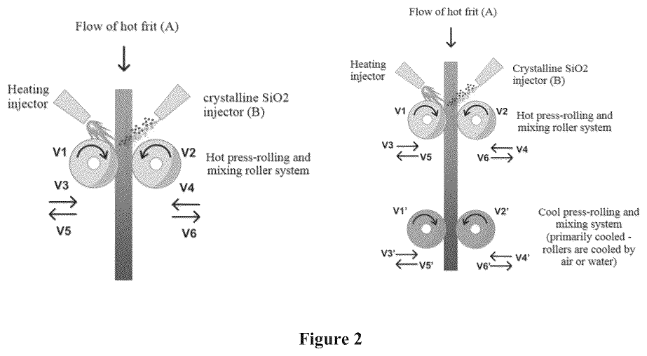

In the first aspect, as shown in FIGS. 1 and 2, the present invention provides a process for producing a hot blended material of amorphous silicon dioxide-crystalline silicon dioxide (Hot Blending silica-PheniGlass™) from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar, the process includes the following steps:
i) heating a mixture of sand, crushed glass and solid waste from quartz stone production in amount of from 60 to 90% by weight together with additional materials which are soda/feldspar (Na₂CO₃) in amount of from 1 to 13% by weight, aluminum oxide/feldspar powder (Al₂O₃) in amount of from 1 to 13% by weight; limestone/dolomite (CaCO₃/MgCO₃) in amount of from 5 to 13% by weight and processing aid at a temperature between 1000° C. and 1600° C. to obtain common molten frit (component A) with amorphous silicon dioxide content in range of from 40 to 80% by weight;
ii) preparing crystalline silicon dioxide (component B) from sand, quartz, cristobalite with a size ≤500 μm, with or without heating process from ambient temperature (25° C.) to 1600° C. before mixing with the component A, the heating depends on the viscosity of the component A and the mixing ratio of the materials comprising the component A and B;
iii) injecting, mixing and hot press-rolling the crystalline silicon dioxide (component B) into the molten amorphous silicon dioxide (component A), together with adjusting the injection pressure of the component B and the flow rate of the component A so that the proportion of the component A is in range from 60 to 95% by weight and the proportion of component B is in range of 2 to 40% by weight, wherein the total silicon dioxide content of the obtaining product ranges from about 80% to 95% by weight; wherein the mixture of A and B is mixed and homogenized through stages:
stage 1: injecting crystalline silicon dioxide (component B), such as sand, quartz, cristobalite with a size ≤500 μm, directly into the molten frit flow of component A, through the hot press-rolling mixing roller system which can adjust the rotating speed, moving speed in and out of the roller and distance between the two rollers to perform a hot rolling-mix for the first time, at this stage the mixture temperature ranges from 1000 to 1600° C.,
stage 2: passing the molten mixture through a cool rolling and mixing roller system which is primarily cooled by water or air and which can adjust the rotating speed, moving speed in and out of the roller and distance between the two rollers to perform a rolling mixing for the second time, at this stage the mixture temperature ranges from 500 to 1000° C.;
iv) passing the molten mixture through a mold or flat heat-resistant conveyor system that has vertical movement perpendicular to roller and mixing and rolling rollers in which the speed and distance between the roller and the conveyor belt can be adjusted in order to adjust the particle size as desired, wherein the roller is secondarily cooled by water or air, at this stage the mixture temperature ranges from 100 to 500° C.;
v) grinding the particles from step (iv) by a mill system to obtain the hot blended material of amorphous silicon dioxide-crystalline silicon dioxide (Hot Blending silica-PheniGlass™) with the desired sizes.

The advantage of this process is that the blended material (A and B) is cooled slowly to increase the hardness of the material, reduces surface cracking and does not require a drying step like the water-cooling system.

In one embodiment of the invention, the blended material has a hardness >5 Mohs, the surface is smooth and does not crack like regular frits and glass.

Amorphous silicon dioxide is observed as transparent areas, while crystalline silicon dioxide is observed as opaque white areas. The structure and component ratios can be analyzed by X-ray diffraction (XRD) and infrared spectroscopy (FTIR).

The material particles obtained from grinding step are composed of amorphous silicon dioxide and crystalline silicon dioxide that is completely or partially enveloped by amorphous silicon dioxide in which the proportion of the component A is in range from 60 to 95% by weight and the proportion of component B is in range of 2 to 40% by weight according to the initially mixed ratio.

In some embodiments, the step (i) is performed by thoroughly mixing the main ingredient and additional ingredients including one or more types of main ingredients in amount of from 60 to 90% by weight such as natural sand, cristobalite, glass/crushed glass, waste rock powder/burrs from process of producing artificial stone, waste products and by-products from the exploitation and processing of natural quartz stone and with or without additives, wherein the content of soda/feldspar (Na₂CO₃) in amount of from 1 to 15% by weight, preferably the content of soda/feldspar (Na₂CO₃) in amount of from 1 to 13% by weight, more preferably the content of soda/feldspar (Na₂CO₃) in amount of from 1 to 12% by weight, and wherein the content of aluminum oxide/feldspar powder (Al₂O₃) in amount of from 1 to 15% by weight, preferably the content of aluminum oxide/feldspar powder (Al₂O₃) in amount of from 1 to 13% by weight, more preferably the content of aluminum oxide/feldspar powder (Al₂O₃) in amount of from 1 to 12% by weight, and wherein the content of limestone/dolomite (CaCO₃/MgCO₃) in amount of from 5 to 15% by weight, preferably the content of limestone/dolomite (CaCO₃/MgCO₃) in amount of from 5 to 15% by weight, more preferably the content of limestone/dolomite (CaCO₃/MgCO₃) in amount of from 5 to 15% by weight, and the additives is in range of from 0 to 10% by weight, preferably in range of from 0 to 1% by weight in order to prepare the mixture.

Here, the molten mixture is heated to a temperature in range of 1000 to 1600° C. in following stages:
stage 1 (heating phase): gradually increase the temperature from room temperature to melting temperature in 2 hours (heating rate ˜10÷20° C./min) to create a molten mixture;
stage 2 (maintaining phase): maintain at firing temperature for 1 to 3 hours.

In some preferred embodiments, in this step, some additives can be used to adjust processing aids, for example to increase physical and mechanical durability such as SiO₂, Al₂O₃, ZrO₂; reduce the firing temperature such as K₂O, Na₂O, CaO, MgO, and increase chemical durability such as CaO, MgO, or color additives from metals or metal oxides such as manganese, selenium, tin oxide.

In one preferred embodiment, in the step (i), the heating to form molten glass frit is performed at the temperature 1300° C. for 2 hours.

In some preferred embodiments, in the step (ii), the crystalline silicon dioxide (component B) is obtained from sand, quartz, cristobalite with a size ≤500 μm, with or without a heating process from ambient temperature (25° C.) to 1600° C. before mixing with the component A, the heating depends on the viscosity of the component A and the mixing ratio of the materials comprising the component A and B.

In some preferred embodiments, the step (iii) is performed by blending the mixture of molten amorphous silicon dioxide (component A) and crystalline silicon dioxide (component B) wherein the proportion of the component A is in range from 60 to 95% by weight and the proportion of component B is in range of 2 to 40% by weight, and the resulting mixture has a total silicon dioxide content in ranges from about 80% to 95% by weight.

The hot blended material of amorphous silicon dioxide-crystalline silicon dioxide (Hot blending Silica-PheniGlass™) is obtained in solid state. Unlike natural quartz stone, which has a crystalline SiO₂ content >99% by weight, the material of Hot blending Silica-PheniGlass™ which has a total silicon dioxide content in ranges from about 80% to 95% by weight wherein the main ingredient is amorphous silicon dioxide in range from 60 to 95% by weight and crystalline silicon dioxide in range of 2 to 40% by weight and a very small portion of other impurities are metal oxides from additives added during the synthesis process such as iron oxide, aluminum oxide, titanium oxide, etc. In addition, in step (iii), the mixing of molten amorphous silicon dioxide (component A) with crystalline silicon dioxide (component B) in order to cover the crystalline silicon dioxide component by amorphous silicon dioxide to reduce the ability to disperse crystalline silicon dioxide during the production and processing of current quartz-based artificial stone products with a silicon dioxide content of >90% by weight which affects the formation and development of silicosis. The homogeneous mixing of molten glass (component A—molten amorphous silicon dioxide) and calcined sand, quartz or critobalite (component B—crystalline silicon dioxide) is carried out on a rolling roller system with heating, in which molten glass (component A) and calcined sand, quartz or critobalite (component B) are injected from rotary furnaces 1 and 2 into the press rolling roller system with heating at a weight ratios of component A/component B=(60÷95% by weight)/(2÷40% by weight), helping to create a blending material of amorphous silicon dioxide and crystalline silicon dioxide in desired content and ratio with total content of silicon dioxide in range of 80% to 95% by weight.

In some embodiment of the invention, in the step iv), the molten mixture passes through two rolling and press mixing rollers (rollers are cooled by water or air). The result is a layer of partially cooled material that falls onto the transport conveyor system (flat conveyor or with small molds underneath made of high temperature resistant material) and continues to be cooled and adjust to size by press rolling system (roller is cooled by air or water). The advantage of this process is that the blended material (A and B) is cooled slowly to increase the hardness of the material, reduces surface cracking and does not require a drying step like the direct water-cooling system.

In one embodiment of the invention, the resulting blended material has a hardness >5 Mohs, the surface is smooth and does not crack like regular frits and glass.

The mixture obtained after cooling will be sieved to remove the crystalline silicon dioxide (component B) that was not blended during the hot blending process between components A and B. This part is sieved and then go back to the hot blending stage to ensure that the resulting mixture is free of unblended crystalline silicon dioxide, mechanically bonded to amorphous silicon dioxide.

In some embodiments of the invention, in the step (v), grinding the particle mass formed in step (iv), to obtain blended material with desired sizes, is carried out as following: particle mass with large sizes is formed from step (iv) after being cooled to room temperature, then put into the grinding equipment to grind into particles with desired size, for example, particle size of 0.1-0.4 mm; particle size of 0.3-0.6 mm; wind powder <0.045 mm.

In one aspect, the present invention relates to blended material of amorphous silicon dioxide-crystalline silicon dioxide of the invention obtained from the process of the invention, wherein the material is consisting of chemical compositions as following:
80%<SiO₂<95% by weight, wherein the amorphous SiO₂ is in range from 60 to 95% by weight; crystalline SiO₂ is in range from 2 to 40% by weight;
1.0%<Na₂O<12% by weight;
1.5%<CaO/MgO<9% by weight;
1.0%<Al₂O₃<10% by weight;
wherein the other additives such as Fe₂O₃<0.1% by weight, TiO₂<0.1% by weight.

In another aspect, the present invention provides a process for producing artificial stone, wherein the process includes the following steps:
i) heating a mixture of sand, crushed glass and solid waste from quartz stone production in amount of from 60 to 90% by weight together with additional materials which are soda/feldspar (Na₂CO₃) in amount of from 1 to 13% by weight, aluminum oxide/feldspar powder (Al₂O₃) in amount of from 1 to 13% by weight; limestone/dolomite (CaCO₃/MgCO₃) in amount of from 5 to 13% by weight and processing aid at a temperature between 1000° C. and 1600° C. to obtain common molten frit (component A) with amorphous silicon dioxide content in range of from 40 to 80% by weight;
ii) preparing crystalline silicon dioxide (component B) from sand, quartz, cristobalite with a size ≤500 μm, with or without heating process (sintering) from ambient temperature (25° C.) to 1600° C. before mixing with the component A, the heating depends on the viscosity of the component A and the mixing ratio of the materials comprising the component A and B;
iii) injecting, mixing and hot press-rolling the crystalline silicon dioxide (component B) into the molten amorphous silicon dioxide (component A), together with adjusting the injection pressure of the component B and the flow rate of the component A so that the proportion of the component A is in range from 60 to 95% by weight and the proportion of component B is in range of 2 to 40% by weight, wherein the total silicon dioxide content of the obtaining product ranges from about 80% to 95% by weight; wherein the mixture of A and B is mixed and homogenized through stages:
stage 1: injecting crystalline silicon dioxide (component B), such as sand, quartz, cristobalite with a size ≤500 μm, directly into the molten frit flow of component A, through the hot press-rolling mixing roller system which can adjust the rotating speed, moving speed in and out of the roller and distance between the two rollers to perform a hot rolling-mix for the first time, at this stage the mixture temperature ranges from 1000 to 1600° C.,
stage 2: passing the molten mixture through a cool rolling and mixing roller system which is primarily cooled by water or air and which can adjust the rotating speed, moving speed in and out of the roller and distance between the two rollers to perform a rolling mixing for the second time, at this stage the mixture temperature ranges from 500 to 1000° C.;
iv) passing the molten mixture through a mold or flat heat-resistant conveyor system that has vertical movement perpendicular to roller and mixing and rolling rollers in which the speed and distance between the roller and the conveyor belt can be adjusted in order to adjust the particle size as desired, wherein the roller is secondarily cooled by water or air, at this stage the mixture temperature ranges from 100 to 500° C.;
v) grinding the particles from step (iv) by a mill system to obtain the hot blended material of amorphous silicon dioxide-crystalline silicon dioxide (Hot Blending silica-PheniGlass™) with the desired sizes;
(vi) producing artificial stone products by using blended material of amorphous silicon dioxide-crystalline silicon dioxide obtained in the step (v) and base resins such as unsaturated polyester, epoxy, acrylic or combination thereof by press-vibration method in a vacuum environment, in which the ratio of base resin used is in range from 6 to 20% by weight and the ratio of blended material of amorphous silicon dioxide-crystalline silicon dioxide obtained in the step (v) is in range from 80 to 94% by weight.

The advantage of this process is that the blended material (A and B) is cooled slowly to increase the hardness of the material, reduces surface cracking and does not require a drying step like the water-cooling system.

In one embodiment of the invention, the blended material has a hardness >5 Mohs, smooth surface, and no crackings on surface compared to conventional frit and glass.

Amorphous silicon dioxide is observed as transparent areas, while crystalline silicon dioxide is observed as opaque white areas. The structure and component ratios can be analyzed by X-ray diffraction (XRD) and infrared spectroscopy (FTIR).

The material particles obtained after grinding at step (v) are composed of amorphous silicon dioxide and crystalline silicon dioxide that is completely or partially enveloped by amorphous silicon dioxide in which the proportion of the component A is in range from 60 to 95% by weight and the proportion of component B is in range of 2 to 40% by weight according to the initially mixed ratio.

In another aspect, the present invention provides a artificial stone product obtained from the process of the invention, wherein the artificial stone product comprises base resins such as unsaturated polyester, epoxy, acrylic with the ratio in range from 6 to 20% by weight and reinforcement is the hot blended material of amorphous silicon dioxide-crystalline silicon dioxide (Hot blending Silica-PheniGlass™) with the ratio in range from 80 to 94% by weight, wherein the total ratio of silicon dioxide is range from 80% to 95% by weight and the artificial stone product has a flexural strength ≥40 N/mm², a water absorption ≤0.025%, an impact resistance ≥3 J.

In some embodiments, in step (vi), the binder used to form the sheet is selected from a group consisting of epoxy resins, unsaturated polyester resins, etc, or any suitable combination thereof. However, the invention is not limited to those resins. The binder resin to form the sheet can be colorlessly transparent or can be colored as required by adding inorganic pigments. The binder resin to form the sheet can be of the type that uses for indoor applications or of the type that is resistant to ultraviolet (UV) for use in outdoor applications.

In some embodiments, the material mixture is press-vibrated in a mold under vacuum pressure conditions of 10 to 25 mbar (1000 to 2500 Pa) to effectively remove the amount of air present in the resin block to form a solid stone sheet maximumly.

To achieve this effect, it is preferable that the press-vibrating process under vacuum conditions is carried out in two or more stages, each lasting from 1 to 10 minutes with a vibration frequency ranging from 500 to 3000 rpm.

In some embodiments, after the press-vibration under vacuum conditions, the mixture in the mold is solidified under cold solidification or hot solidification conditions depending on the type of binder resin used. The solidification ends when the binder resin is cured and completely dry.

In other aspect, the present invention provides an artificial stone product using reinforcement of the hot blended material of amorphous silicon dioxide-crystalline silicon dioxide (Hot blending Silica-PheniGlass™) which has properties as shown in Table 1:

| Physical and mechanical properties | Test method | Value |
|---|---|---|
| Water absorption, % | BS EN 14617-1: 2013 | ≤0.025 |
| Flexural strength, N/mm² | BS EN 14617-2: 2016 | ≥40.0 |
| Impact resistance, J | BS EN 14617-9: 2005 | ≥3.0 |
| Scratch hardness of surface, Mohs | EN 101: 1991 | ≥6.0 |

The blended material of amorphous silicon dioxide-crystalline silicon dioxide of the invention (Hot blending Silica-PheniGlass™) has a hardness >5 Mohs, smooth surface, reduced surface cracks compared to conventional frit products and especially with the advantage of not generating silica dust in the shaped form or controlled emission during the production and processing of a artificial stone products, thereby reducing harmful effects on human health through the respiratory tract due to the use of materials such as quartz/silica sand.

### EXAMPLES

The invention is illustrated by the following examples, but these examples should not be construed to limit the scope of the invention in any way.

Example 1: Process for producing a hot blended material of amorphous silicon dioxide-crystalline silicon dioxide (Hot Blending silica-PheniGlass™) from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar, etc

### Preparing Molten Glass (Component A—Moltent Amorphous Silicon Dioxide)

500 kg of natural sand in a dry state with an average particle size of 0.5 mm, 500 kg of crushed glass from the broken glass which is a waste product of the glass factory crushed into a size of <10 mm, 600 kg of by-products from the artificial stone production and 260 kg of Na₂CO₃>99% by weight, 90 kg of aluminum oxide powder, 120 kg of limestone are mixed together to obtain a mixture.

This mixture is put into the furnace and heated from ambient temperature to 1450° C. for 2 hours (heating rate ˜15° C./min), maintaining time is 2 hours, the resulting product is molten glass (component A).

Add tin oxide with antimony and zinc oxide to create opaque white molten amorphous silicon dioxide.

### Preparing Crystalline Silicon Dioxide (Component B)

550 kg of sand is heated at a temperature of 800° C. to remove impurities to obtain calcined sand with impurities removed (component B1).

A mixture of 495 kg of above-obtained sand and 5 kg of Na₂CO₃ (ensuring the additive ratio is 1% by weight) is put into rotary furnace 2. The heating process is performed from ambient temperature to 1500° C. for 2 hours (heating rate ˜12° C./min), maintaining time is 2 hours, the resulting product is cristobalite (component B).
injecting, mixing and hot press-rolling the crystalline silicon dioxide (component B) into the molten amorphous silicon dioxide (component A), together with adjusting the injection pressure of the component B and the flow rate of the component A so that the proportion of the component A is in range from 60 to 95% by weight and the proportion of component B is in range of 2 to 40% by weight, wherein the total silicon dioxide content of the obtaining product ranges from about 80% to 95% by weight; wherein the molten mixture is passed through a press roller system with heating and the mixture of A and B is mixed and homogenized through stages:
stage 1: the crystalline silicon dioxide (component B) with a size ≤500 μm is injected directly into the molten frit stream of component A, through the hot press-rolling mixing roller system which can adjust the rotating speed, moving speed in and out of the roller and distance between the two rollers to perform a hot rolling-mix for the first time. The mixture temperature ranges from 1000 to 1600° C.,
stage 2: the molten mixture is passed through a cool rolling and mixing roller system which is primarily cooled by water or air and which can adjust the rotating speed, moving speed in and out of the roller and distance between the two rollers to perform a rolling mixing for the second time. The mixture temperature ranges from 500 to 1000° C.

The molten mixture is passed through a mold-type heat-resistant conveyor system that has vertical movement perpendicular to roller and mixing and rolling rollers in which the speed and distance between the roller and the conveyor belt can be adjusted in order to adjust the particle size as desired, wherein the roller is secondarily cooled by water or air. The mixture temperature ranges from 100 to 500° C.

The advantage of this process is that the blended material (A and B) is cooled slowly to increase the hardness of the material, reduces surface cracking and does not require a drying step like the water-cooling system.

In one embodiment of the invention, the blended material has a hardness >5 Mohs, smooth surface, and no crackings on surface compared to conventional frit and glass.

After cooling, the block of semi-finished granules with large particle size is fed into the grinding system and grined into desired particle sizes such as:

| Particle sizes | 1 | 2 | 3 | 4 | 5 | 6 |
|---|---|---|---|---|---|---|
| 0.1-0.4 mm | <0.045 | 0.045-0.1 | 0.1-0.3 | 0.3-0.4 | 0.4-0.5 | >0.5 |
| | 0.0% | ≤10.0% | 40-55% | 35-50% | ≤10% | 0.0% |
| 0.3-0.7 mm | <0.2 | 0.2-0.3 | 0.3-0.5 | 0.5-0.7 | 0.7-0.8 | >0.8 |
| | 0.0% | ≤10.0% | 10-25% | 65-80% | ≤10.0% | 0.0% |
| 0.5-1.2 mm | <0.4 | 0.4-0.5 | 0.5-1.0 | 1.0-1.2 | 1.2-1.5 | >1.5 |
| | 0.0% | ≤8.0% | 30-45% | 35-50% | 10-20% | 0.0% |

Results of analysis of technical characteristics, proportion of crystalline SiO₂, amorphous SiO₂ (through X-ray diffraction (XRD) and infrared spectroscopy (FTIR)) of the material of Hot blending Silica-PheniGlass™ M obtained according to the present invention when compared with samples of crushed glass and commercial silicon dioxide are shown in the following table:

TABLE 2
Chemical composition of the material of Hot blending Silica - PheniGlass ™, crushed
glass and commercial silicon dioxide

| | | | | | | | | | | Weight |
|---|---|---|---|---|---|---|---|---|---|---|
| | | | | | | | | | | loss |
| Chemical | | | | | | | | | | after |
| composition | SiO₂ | Fe₂O₃ | Al₂O₃ | CaO | MgO | SO₃ | K₂O | Na₂O | TiO₂ | heated |
| unit | % | % | % | % | % | % | % | % | % | % |
| PheniGlass ™ 02 | 78.59 | 0.21 | 7.05 | 5.80 | 0.06 | 0.00 | 0.38 | 6.09 | 0.24 | 0.02 |
| | (amorphous) | | | | | | | | | |
| | 1.56 | | | | | | | | | |
| | (crystalline) | | | | | | | | | |
| | total 80.15 | | | | | | | | | |
| PheniGlass ™ 20 | 63.53 | 0.20 | 5.82 | 4.52 | 0.06 | 0.00 | 0.37 | 5.51 | 0.23 | 0.02 |
| | (amorphous) | | | | | | | | | |
| | 19.92 | | | | | | | | | |
| | (crystalline) | | | | | | | | | |
| | total 83.45 | | | | | | | | | |
| PheniGlass ™ 40 | 61.85 | 0.26 | 6.42 | 4.59 | 0.08 | 0.01 | 0.37 | 6.00 | 0.30 | 0.03 |
| | (amorphous) | | | | | | | | | |
| | 38.15 | | | | | | | | | |
| | (crystalline) | | | | | | | | | |
| | total 81.94 | | | | | | | | | |
| crushed glass | 66.27 | 0.30 | 8.42 | 5.40 | 0.20 | 0.00 | 0.55 | 15.47 | 0.19 | 0.00 |
| commercial | 99.16 | 0.04 | 0.03 | 0.00 | 0.00 | 0.00 | 0.00 | 0.00 | 0.09 | 0.17 |
| silicon dioxide | | | | | | | | | | |
| (sand, quartz) | | | | | | | | | | |

Note:
for example, a PheniGlass ™ obtained from the invention with crystalline silicon dioxide content of 19.92%, total silicon dioxide content of 83.45% is called as PheniGlass ™ 20 (it means that PheniGlass ™ 20 is a PheniGlass ™ material which has the crystalline silicon dioxide content of about 20%)

Also, in other examples when adjusting the desired amorphous silicon dioxide ratio will give results as shown in table 3 or the like:

TABLE 3
the products of Hot blending Silica - PheniGlass ™ obtained
from the present invention

| | Component A | | Component B | | The total |
|---|---|---|---|---|---|
| | (amorphous | | (crystalline | | content of |
| | silicon | | silicon | | silicon |
| | dioxide), %, | | dioxide), % | | dioxide in |
| | % in | % | % in | % | A/B miture, |
| Product type | mixture | SiO2 | mixture | SiO2 | % |
| PheniGlass ™ 02 | 98 | 80 | 2 | 99.9 | 80.4 |
| PheniGlass ™ 05 | 95 | 80 | 5 | 99.9 | 81.0 |
| PheniGlass ™ 10 | 90 | 80 | 10 | 99.9 | 82.0 |
| PheniGlass ™ 20 | 80 | 80 | 20 | 99.9 | 84.0 |
| PheniGlass ™ 30 | 70 | 80 | 30 | 99.9 | 86.0 |
| PheniGlass ™ 40 | 60 | 80 | 40 | 99.9 | 88.0 |

### Color

The color of the silica sample was determined on a colorimeter Xrite C17800, Xrite, US. Color measurement method based on the principle of reflection using CIE Lab color space, L*, a*, b*, ΔE* according to ASTM E313-10:2010. The results are shown in Table 4,
wherein:
L*: white/black (L=100: white; L=0: black)
a*: magenta/green (a*=0÷100: magenta; a*=0÷−100: green)
b*: yellow/blue (b*=0÷100: yellow; a*=0÷−100: blue).

TABLE 4
The L*, a*, b* parameters of the samples of Hot blending
Silica - PheniGlass ™ material in the invention
and commercial silicon dioxide

| Samples | L* | a* | b* |
|---|---|---|---|
| PheniGlass ™ 02 | 95.60 | −0.43 | 0.89 |
| PheniGlass ™ 05 | 95.51 | −0.39 | 0.93 |
| PheniGlass ™ 10 | 95.35 | −0.31 | 1.01 |
| PheniGlass ™ 20 | 95.02 | −0.10 | 1.18 |
| PheniGlass ™ 30 | 94.66 | 0.11 | 1.44 |
| PheniGlass ™ 40 | 93.94 | −0.20 | 2.25 |
| Commercial silicon dioxide | 93.51 | 0.25 | 3.02 |

### Example 2: Effect of PheniGlass™ Materials Obtained in Example 1 on the Machinability and Physical and Mechanical Properties of Artificial Stone Products

Use the PheniGlass™ material of example 1 with different ranges of particle size and different blending ratios according to the calculated optimal formula to create the samples of artificial stone in the laboratory and compare with the sample of artificial stone used completely crystalline SiO₂ material with the same optimal method and formula.

The artificial stone samples using unsaturated polyester resin, are made by press vibration method in a vacuum environment and are cured by heating method at 125° C. for 35 minutes and have the dimensions of 300×300×20 mm. The total weight of raw materials to make the stone samples is 5000 g. In particular, the mixed ingredients to make artificial stone samples include 595 g of unsaturated polyester resin (11.9% of the total weight of raw materials), the resin includes additives for curing process. The PheniGlass material of example 1 or crushed glass, that used, includes 1220 g in form of powder with a size ≤0.1 mm (24.400 of total material weight) and 3185 g in form of powder with a size of 0.1=0.4 mm (63.7% of total material weight).

The machinability and physical and mechanical properties of the artificial stone products with the above mixing formula are shown in the following Table 5.

TABLE 5
Comparison of the machinability of the samples of the artificial stone products
using PheniGlass ™ materials, crushed glass and commercial silicon dioxide

| | Materials | | | | | |
|---|---|---|---|---|---|---|
| | | | | | Commercial | |
| | | | | | silicon | |
| | | | | | dioxide | Natural |
| | PheniGlass ™ | PheniGlass ™ | PheniGlass ™ | Crushed | (quartz, | granite |
| Parameters | 02 | 20 | 40 | glass | sand) | stone |
| Flexible | Flexible | Flexible | Flexible | Less | Flexible | when |
| material after | | | | Flexible | | processing |
| press vibration | | | | | | |
| Curing | 125 | 125 | 125 | 125 | 125 | |
| temperature | | | | | | |
| (° C.) | | | | | | |
| Curing time | 35 | 35 | 35 | 35 | 35 | |
| (min) | | | | | | |
| The sample | Not blistered | Not blistered | Not blistered | Blistered | Not blistered | |
| after curing | and pitted | and pitted | and pitted | and pitted | and pitted | |
| Arading ability | Easy to abrade, | Easy to abrade, | Easy to abrade, | difficult to | Easy to | |
| | no scratches on | no scratches on | no scratches on | abrade, | abrade, no | |
| | the surface | the surface | the surface | has | scratches on | |
| | | | | scratches | the surface | |
| | | | | on the | | |
| | | | | surface | | |
| Cutting and | Easy to process | Easy to process | Easy to process | Easy to | Easy to | |
| processing | | | | chip or | process | |
| ability | | | | break | | |
| | | | | when | | |
| | | | | processing | | |

The artificial stone products, using the materials of PheniGlass™ and regular silicon dioxide, have similar curing time, flexible material after press vibration, polishing, and no scratches on the surface (table 5). Meanwhile, the artificial stone sample using crushed glass is difficult to process, less flexible after press vibration, blistered, pitted and difficult to abrade, has scratches on the surface, and is not polishing.

TABLE 6
Effect of materials on the physical and mechanical
properties of the artificial stone product

| | Properties | | | |
|---|---|---|---|---|
| | | | | Scratch |
| | Flexural | Water | Impact | hardness of |
| | strength, | absorption, | resistance, | surface, |
| | N/mm² | % | J | Mohs |
| | Test method | | | |
| | BS EN | BS EN | BS EN | |
| | 14617-2: | 14617-1: | 14617-9: | EN 101: |
| | 2016 | 2013 | 2005 | 1991 |
| Standard value | ≥40.0 | ≤0.025 | ≥3.0 | ≥6.0 |
| PheniGlass ™ 02 | 89.71 | 0.018 | 7.96 | 6 |
| PheniGlass ™ 20 | 87.00 | 0.016 | 8.53 | 7 |
| PheniGlass ™ 40 | 90.23 | 0.015 | 10.05 | 7 |
| Crushed glass | 33.51 | 0.055 | 2.85 | 4 |
| Commercial | 73.92 | 0.019 | 7.01 | 7 |
| silicon dioxide | | | | |
| (quartz, sand) | | | | |
| Natural granite | 13.50 | 0.110 | 3.82 | 6 |
| stone | | | | |

From Table 6, it can be seen that the artificial stone products using PheniGlass™ materials have physical and mechanical properties equivalent to artificial stone products using commercial silicon dioxide and have superior properties compared to natural granite samples. The artificial stones using the Hot blending Silica-PheniGlass™ material have good flexural strength and impact resistance, this results to easy processing and not cause chipping or breakage.

The Hot blending Silica-PheniGlass™ material obtained from this process has a hardness >5 Mohs, reduced surface cracks compared to conventional frit product and especially with the advantage of not generating silica dust in the shaped form or controlled emission during the production and processing of an artificial stone products, thereby reducing harmful effects on human health through the respiratory tract due to the use of materials such as quartz/silica sand.

### The Advantageous Effect of the Invention

Unlike the use of commercial silica (>99% crystalline silicon dioxide) in the production of artificial stone, the process of the present invention produces the material of hot blending Silica-PheniGlass™ from materials containing silicon dioxide such as sand, quartz, cristobalite, crushed glass, waste rock powder/burrs from process of producing artificial stone, waste products and by-products from the exploitation and processing of natural quartz stone and common frit materials such as kaolin, schist, feldspar, in which the materials have the amorphous silicon dioxide content is in range from 60 to 95% by weight and the crystalline silicon dioxide content is in range from 2 to 40% by weight, the total silicon dioxide content in ranges from about 80% to 95% by weight, and have a hardness greater than 5 Mohs, as well as smooth surface, not cracked like regular glass and frit that used for the production of artificial stone, thus the materials can be processed more easily than natural granite and ensure the possibility of silicon dust generation below the allowable level similar to natural granite. The process of the present invention combines molten amorphous silicon dioxide (molten glass) and crystalline silicon dioxide (sand, quartz, cristobalite . . . ) to create a new material type of Hot blending Silica-PheniGlass™ which has properties similar to commercial silicon dioxide with a total silicon dioxide content of about 80% to 95% by weight.

The process of the present invention takes advantage of solid waste from quartz stone production (waste rock powder/burrs from process of producing artificial stone with particle size ranging from 0.1 to 10 mm), waste products, by-product from the exploitation and processing of natural quartz stone, and helps minimize solid emissions into the environment thanks to the appropriate mixing process and heat map of the heating of the raw material mixture to create molten glass during the heating step. Besides, the homogeneous mixing helps control the ratio of amorphous silicon dioxide and crystalline silicon dioxide to obtain the Hot blending Silica-PheniGlass™ product with the desired content and composition of amorphous silicon dioxide.

The Hot blending Silica-PheniGlass™ material of the present invention has properties similar to quartz/silica sand with a hardness >5 Mohs, smooth surface, reduced surface cracks compared to conventional frit products and especially with the advantage of not generating silica dust in the shaped form or controlled emission during the production and processing of a artificial stone products, thereby reducing harmful effects on human health through the respiratory tract due to the use of materials such as quartz/silica sand.

The present invention has provided an artificial stone product using a reinforcement that is the Hot blending Silica-PheniGlass™ material or mixture of the Hot blending Silica-PheniGlass™material with quartz, cristobalite, sand, glass, frit, etc. The artificial stone product of the invention has a flexural strength ≥40 N/mm², a water absorption ≤0.025%, an impact resistance ≥3 J.

1. A process for producing a hot blended material of amorphous silicon dioxide-crystalline silicon dioxide with hardness greater than or equal to 5 Mohs and with silicon dioxide content in a range from 80% to 95% by weight, wherein a portion the crystalline silicon dioxide is in a range from 2 to 40% by weight, the process comprises the following steps:
i) heating a mixture of sand, crushed glass and solid waste from quartz stone production in amount of 60 to 90% by weight together with Na₂CO₃ in amount of 1 to 13% by weight, Al₂O₃ in amount of 1 to 13% by weight, CaCO₃/MgCO₃ in amount of 5 to 13% by weight and processing aid at a temperature between 1000° C. and 1600° C. to obtain common molten frit with amorphous silicon dioxide in range of 40 to 80% by weight;
ii) preparing crystalline silicon dioxide from the sand, quartz, and cristobalite with a size ≤500 μm, with or without a heating process from 25° C. to 1600° C. before mixing with the common molten frit with amorphous silicon dioxide;
iii) injecting, mixing and hot press-rolling the crystalline silicon dioxide into the common molten frit with amorphous silicon dioxide, together with adjusting an injection pressure of the crystalline silicon dioxide and a flow rate of the common molten frit with amorphous silicon dioxide so that a proportion of the common molten frit with amorphous silicon dioxide is in range from 60 to 95% by weight and a proportion of the crystalline silicon dioxide is in range of 2 to 40% by weight, wherein a total silicon dioxide of an obtained product ranges from about 80% to 95% by weight; wherein a mixture of the common molten frit with amorphous silicon dioxide and the crystalline silicon dioxide is mixed and homogenized through stages:
stage 1: injecting the crystalline silicon dioxide directly into a molten frit stream of the common molten frit with amorphous silicon dioxide, through a hot press-rolling mixing roller system which is configured to adjust a rotating speed, moving speed in and out of a roller and distance between two rollers to perform a hot rolling-mix for a first time to yield a molten mixture, at this stage a mixture temperature ranges from 1000 to 1600° C., and
stage 2: passing the molten mixture through a cool rolling and mixing roller system which is primarily cooled by water or air and which is configured to adjust the rotating speed, the moving speed in and out of the roller and the distance between the two rollers to perform a rolling mixing for a second time, at this stage the mixture temperature ranges from 500 to 1000° C.;
iv) passing the molten mixture, after the stage 2, through a mold or flat heat-resistant conveyor system that has vertical movement perpendicular to the roller and mixing and rolling rollers in which a speed and distance between the roller and a conveyor belt is configured to be adjusted in order to adjust a particle size as specified to yield particles, wherein the roller is secondarily cooled by water or air, at this stage the mixture temperature ranges from 100 to 500° C.; and
v) grinding the particles from the step (iv) by a mill system to obtain the hot blended material of amorphous silicon dioxide-crystalline silicon dioxide with specified sizes.

2. The process according to claim 1, wherein at the step (i), the heating to form the common molten frit with amorphous silicon dioxide is performed at the temperature from 1000 to 1600° C. for 2 h.

3. The process according to claim 1, wherein at the step (ii), the crystalline silicon dioxide is obtained from the sand, the quartz, the cristobalite with a size ≤500 μm, with the heating process from 25° C. to 1600° C. before mixing with the common molten frit with amorphous silicon dioxide.

4. A material obtained from the process according to claim 1, wherein the material consists of following:
80%<SiO₂<95% by weight, wherein the amorphous silicon dioxide is in range from 60 to 95% by weight; the crystalline silicon dioxide is in range from 2 to 40% by weight;
1.0%<Na₂O<12% by weight;
1.5%<CaO/MgO<9% by weight;
1.0%<Al₂O₃<10% by weight;
Fe₂O₃<0.1% by weight; and
TiO₂<0.1% by weight.

5. A process for producing artificial stone, wherein the process comprises the following steps:
i) heating a mixture of sand, crushed glass and solid waste from quartz stone production in amount of 60 to 90% by weight together with Na₂CO₃ in amount of 1 to 13% by weight, Al₂O₃ in amount of 1 to 13% by weight, (CaCO₃/MgCO₃ in amount of 5 to 13% by weight and processing aid at a temperature between 1000° C. and 1600° C. to obtain common molten frit with amorphous silicon dioxide in range of from 40 to 80% by weight;
ii) preparing crystalline silicon dioxide from the sand, quartz, and cristobalite with a size ≤500 μm, with or without a heating process from 25° C. to 1600° C. before mixing with the common molten frit with amorphous silicon dioxide;
iii) injecting, mixing and hot press-rolling the crystalline silicon dioxide into the common molten frit with amorphous silicon dioxide, together with adjusting an injection pressure of the crystalline silicon dioxide and a flow rate of the common molten frit with amorphous silicon dioxide so that a proportion of the common molten frit with amorphous silicon dioxide is in range from 60 to 95% by weight and a proportion of the crystalline silicon dioxide is in range of 2 to 40% by weight, wherein a total silicon dioxide content of an obtained product ranges from about 80% to 95% by weight; wherein a mixture of the common molten frit with amorphous silicon dioxide and the crystalline silicon dioxide is mixed and homogenized through stages:
stage 1: injecting the crystalline silicon dioxide directly into a molten frit stream of the common molten frit with amorphous silicon dioxide, through a hot press-rolling mixing roller system which is configured to adjust a rotating speed, moving speed in and out of a roller and distance between two rollers to perform a hot rolling-mix for a first time to yield a molten mixture, at this stage a mixture temperature ranges from 1000 to 1600° C., and
stage 2: passing the molten mixture through a cool rolling and mixing roller system which is primarily cooled by water or air and which is configured to adjust the rotating speed, the moving speed in and out of the roller and the distance between the two rollers to perform a rolling mixing for a second time, at this stage the mixture temperature ranges from 500 to 1000° C.;
iv) passing the molten mixture, after the stage 2, through a mold or flat heat-resistant conveyor system that has vertical movement perpendicular to the roller and mixing and rolling rollers in which a speed and distance between the roller and a conveyor belt is configured to be adjusted in order to adjust a particle size as specified to yield particles, wherein the roller is secondarily cooled by water or air, at this stage the mixture temperature ranges from 100 to 500° C.;
v) grinding the particles from the step (iv) by a mill system to obtain the hot blended material of amorphous silicon dioxide-crystalline silicon dioxide with specified sizes; and
(vi) producing artificial stone products by using blended material of the amorphous silicon dioxide-crystalline silicon dioxide obtained in the step (v) and base resins by press-vibration method in a vacuum environment, in which a ratio of the base resin used is in range from 6 to 20% by weight and a ratio of the blended material of the amorphous silicon dioxide-crystalline silicon dioxide obtained in the step (v) is in range from 80 to 94% by weight.

6. The process for producing artificial stone according to claim 5, wherein the artificial stone products comprise the base resins with the ratio in range from 6 to 20% by weight and is the hot blended material of amorphous silicon dioxide-crystalline silicon dioxide with the ratio in range from 80 to 94% by weight, wherein a total ratio of silicon dioxide is range from 80% to 95% by weight and the artificial stone products have a flexural strength ≥40 N/mm², a water absorption ≤0.025%, and an impact resistance ≥31.
